(19) United States
(12) Patent Application Publication
(10) Pub. No.: US 2016/0207436 A1
(43) Pub. Date: Jul. 21, 2016

(54) SYSTEMS AND METHODS FOR A PORTABLE HAULER APPARATUS

(71) Applicant: Toy Tote, Lake Havasu City, AZ (US)

(72) Inventor: Milfred William Thomas, Lake Havasu City, AZ (US)

(21) Appl. No.: 15/001,646

(22) Filed: Jan. 20, 2016

Related U.S. Application Data
(60) Provisional application No. 62/105,419, filed on Jan. 20, 2015.

(51) Int. Cl. B60P 3/077; B62D 65/00

(52) U.S. Cl. CPC B60P 3/077; B62D 65/00; B60R 2011/0084

(57) ABSTRACT

Embodiments of a portable hauler apparatus having a frame defining first and second channel portions and a plurality of adjustable chock members configured to be coupled to the first and second channel portions at one or more predetermined locations along the frame are disclosed. The adjustable chock members each define opposite first and second side portions and opposite first and second cross bar portions that collectively form a chock configured to accommodate different types of wheels of a vehicle loaded onto the frame. In another aspect, the portable hauler apparatus is configured to be conveniently disassembled for storage in a toy hauler or trailer.

### CROSS REFERENCE TO RELATED APPLICATIONS

This is a non-provisional application that claims benefit to U.S. provisional application Ser. No. 62/105,419, filed on Jan. 20, 2015, which is incorporated by reference in its entirety.

### FIELD

The present document relates generally to a portable hauler apparatus capable of hauling an off-road vehicle, and in particular to systems and methods for a portable hauler apparatus having a frame that is configurable to haul different types of off-road vehicles and is adapted for convenient disassembly and storage.

### BACKGROUND

Off-roading has become a popular recreational activity around the country, especially in rural, beach and desert areas, which provide terrain suitable for off-road vehicles to drive relatively unencumbered. In the United States alone, the number of off-road vehicle users since 1972 has climbed sevenfold from five million to 36 million in 2000. Specialized commercially-available off-road vehicles include All-Terrain Vehicles (ATVs), dirt bikes, and dune buggies, which are designed for off-roading activities.

When traveling to off-road recreational areas, a specialized travel trailer, commonly referred to as a toy hauler, may be configured to accommodate the storage of an off-road vehicle in the rear portion of the toy trailer. Typically, the toy hauler is a travel trailer with a living area that accommodates a garage area located in the rear of the toy hauler. The toy hauler includes a rear ramp door that that opens into the garage area and allows the off-road vehicle a means of ingress and egress from the garage area of the toy hauler when being transported.

Although toy haulers provide a convenient way of transporting an off-road vehicle, most off-road enthusiasts will park their toy hauler at an RV park or campsite, and are required to drive their off-road vehicle to the off-road recreational area. Unfortunately, many states, such as California, have regulations that prohibit the driving of off-road vehicles on public roads or highways, thereby preventing the off-road enthusiast from directly accessing the off-road recreational area with their off-road vehicle.

As such, there is a need for a portable hauler apparatus that is configured to be stored within the garage area of the toy hauler without unloading the off-road vehicle from the frame of the portable hauler apparatus. In addition, there is a need for a portable hauler apparatus that easily disassembled for convenient storage within the toy hauler as well as assembled therein without having to unload the off-road vehicle from the frame of the portable hauler apparatus. There is a further need for a portable hauler apparatus that is allows convenient storage and deployment from a garage area of a toy hauler.

### SUMMARY

In one embodiment, a portable hauler apparatus includes a frame having a first and second inner side members and first and second outer member engaged between a front member and a rear member for collectively forming a first ladder portion and a second ladder portion; one or more fixed cross members extending between the first inner side member and first outer side member of the first a first ladder portion and extending between the second inner side member and the second outer side member of the second ladder portion; a pair of larger wheels engaged to the frame, and a pair of smaller wheels engaged proximate either the front member or the rear member. In some embodiments, the portable hauler apparatus includes an extension member that engages to either the rear member or the front member for extending the length of the frame to accommodate larger vehicles.

In one aspect, the portable hauler apparatus is designed to be disassembled and stored within a trailer alongside an off-road vehicle.

In another aspect, the portable hauler apparatus includes adjustable chock members which may be secured to the frame at various predetermined locations to provide chocks that are configured to accommodate the tires of different types of off-road vehicles on the frame.

In yet another aspect, the portable hauler apparatus includes an extension member that may be engaged to the rear portion of the frame to extend the length of the portable hauler apparatus to accommodate larger off-road vehicles.

In a further aspect, the portable hauler apparatus includes components configured to easily disengage the roller wheels, main wheels, and the hitch assembly from the frame for complete disassembly of the portable hauler apparatus.

In one method of use, the portable hauler apparatus may be driven up the rear door ramp of a trailer such that the roller wheels of the portable hauler apparatus are in contact with the rear door ramp while the main wheels of the portable hauler apparatus are raised above the rear door ramp and underlying surface, thereby allowing convenient disengagement of the main wheels from the frame to permit storage of the portable hauler apparatus within the toy trailer.

### BRIEF DESCRIPTION OF THE DRAWINGS

FIG. 1 is a perspective view of one embodiment of a portable hauler apparatus having a frame loaded with an off-road vehicle;

FIG. 2 is a perspective view of the frame of the portable hauler apparatus;

FIG. 3 is a top plan view of the frame in an assembled state;

FIG. 4 is a top plan view of the frame in a disassembled state;

FIG. 5 is a perspective view of an adjustable chock member engaged to the frame;

FIG. 6 is a top plan view of the adjustable chock member engaged to the frame;

FIG. 7 is a perspective view of the adjustable chock member;

FIG. 8 is a top plan view of the adjustable chock member;

FIG. 9 is a perspective view of the portable hauler apparatus with the roller wheels being driven up a rear door ramp of a toy hauler;

FIG. 10 is an enlarged view of the portable hauler apparatus showing the main wheels raised above the underlying surface as the roller wheels are in contact with rear door ramp of the toy hauler; and

FIG. 11 is an enlarged view showing an extension secured to the rear portion of the frame for accommodating larger off-road vehicles.

Corresponding reference characters indicate corresponding elements among the view of the drawings. The headings used in the figures do not limit the scope of the claims.

### DETAILED DESCRIPTION

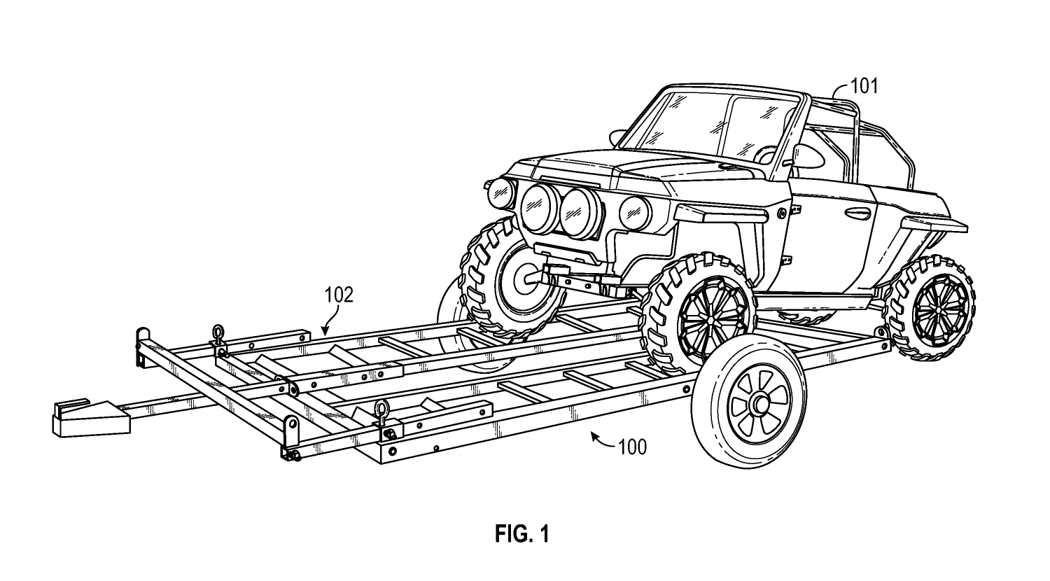

Various embodiments of a portable hauler apparatus configured to load and carry an off-road vehicle while being configured to be disassembled and stored inside a toy hauler or other type of trailer alongside the off-road vehicle is described herein. In addition, methods of assembling, disassembling and storing the portable hauler apparatus are also described. Referring to the drawings, embodiments of a portable hauler apparatus are illustrated and generally indicated as 100 in FIGS. 1-11.

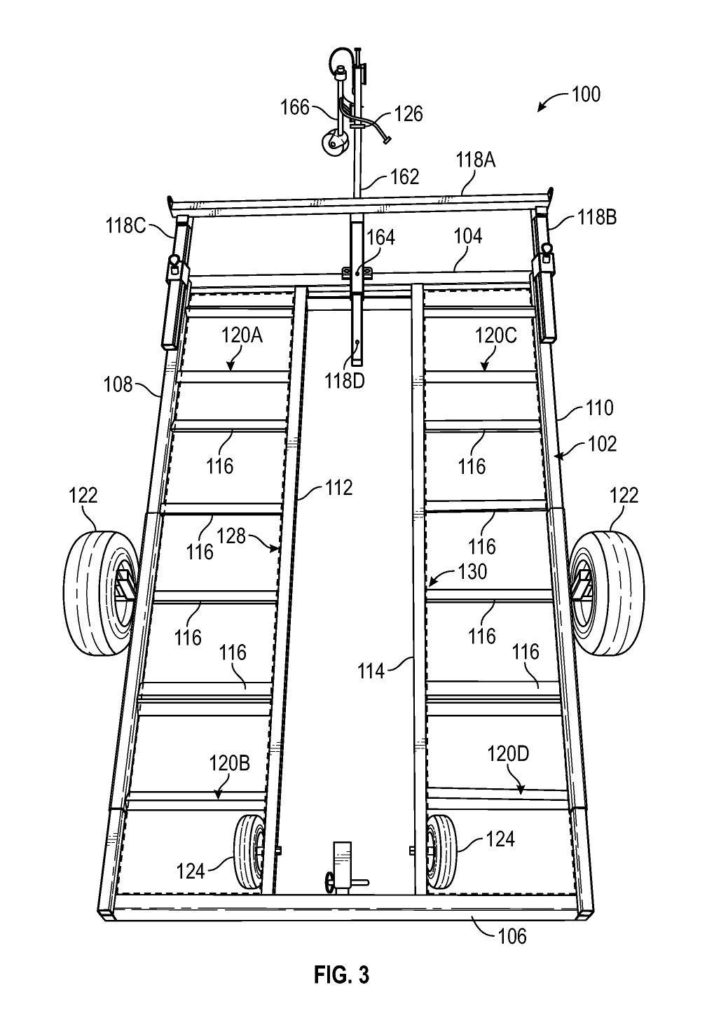

Referring to FIGS. 1-4, the portable hauler apparatus 100 includes a generally rectangular-shaped frame 102 configured to support an off-road vehicle 101 thereon. In particular, the frame 102 may be configured to accommodate different types and sizes of off-road vehicles 101 using various adjustable components to reconfigure the frame 102 for a particular off-road vehicle 101. In some embodiments, the frame 102 includes a front member 104 connected to a rear member 106 through a first outer member 108, a second outer member 110, a first inner member 112, and second inner member 114, which are arranged in parallel orientation relative to each other and in perpendicular relation to the front and rear member 104 and 106. As shown in FIG. 3, the first outer member 108 and first inner member 112 collectively define a first channel portion 128 (denoted in phantom line) with the front and rear members 104 and 108. Similarly, the second outer member 110 and second inner member 114 collectively define a second channel portion 130 (denoted in phantom line) with the front and rear member 104 and 106. The first and second channel portions 128 and 130 each define substantially identical rectangular-shaped dimensions, which are configured to receive the tires of an off-road vehicle 101 loaded onto the frame 102 of the portable hauler apparatus 100.

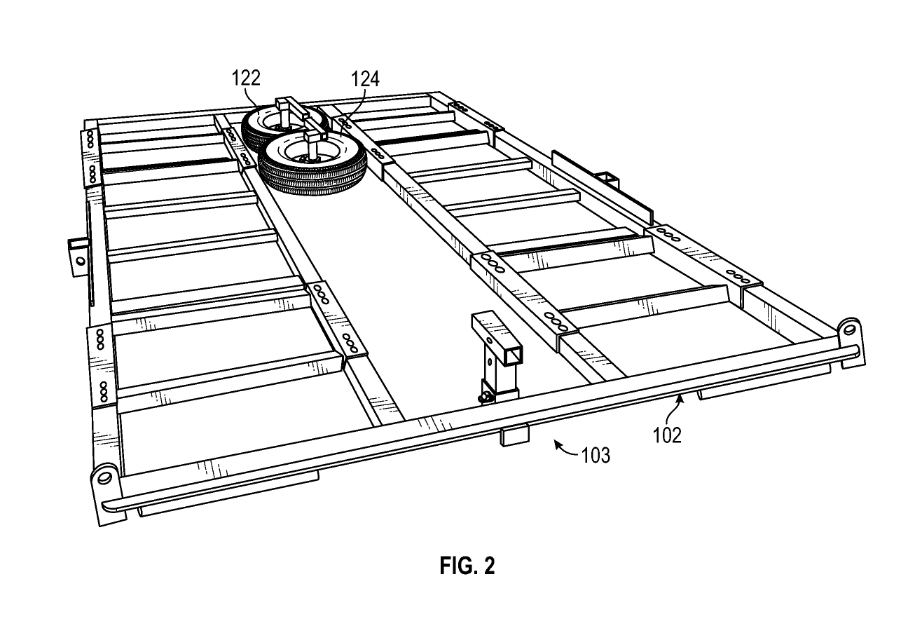

As shown in FIGS. 2 and 3, the frame 102 includes a plurality of fixed cross members 116 that extend between the first outer member 108 and first inner member 112 that form the first channel portion 128. In addition, another plurality of fixed cross members 116 also extend between the second outer member 110 and second inner member 114 that form the second channel portion 130. The fixed cross members 116 provide structural strength to the frame 102 and may also serve as fixed chocks along the first and second channel portions 128 and 130 configured to engage a respective tire of an off-road vehicle 101 being hauled by the portable hauler apparatus 100.

As shown in FIGS. 2-8, the portable hauler apparatus 100 includes four adjustable chock members 120 configured to be engaged along respective portions of the first and second channel portions 128 and 130 of the frame 102, thereby establishing a respective chock tailored to engage a respective tire of an off-road vehicle 101 loaded onto the frame 102. In one embodiment, four adjustable chock members 120 are secured to the frame 102 in which each adjustable chock member 120 is identical in configuration. By way of example, each adjustable chock member 120A-D may have a substantially square or rectangular-shaped frame body 125 defining a first side portion 140, an opposite second side portion 142, a first cross bar portion 144, and an opposite second cross bar portion 146 configured to accommodate a respective tire of off-road vehicle 101.

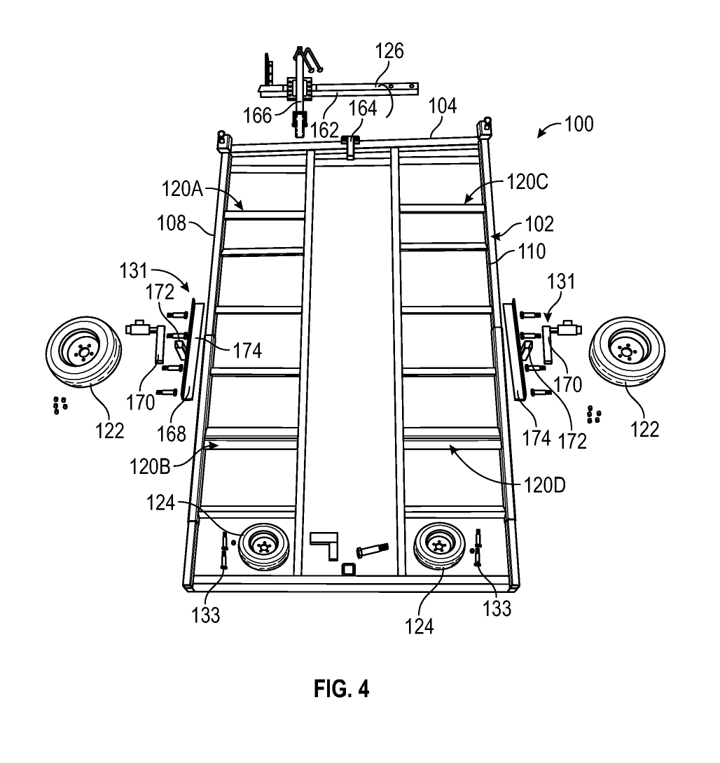

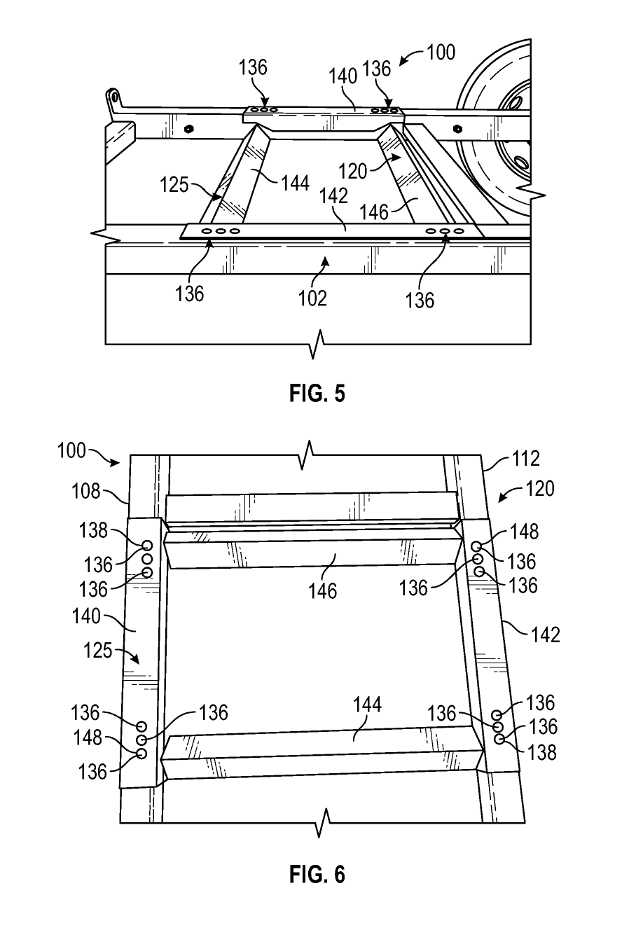

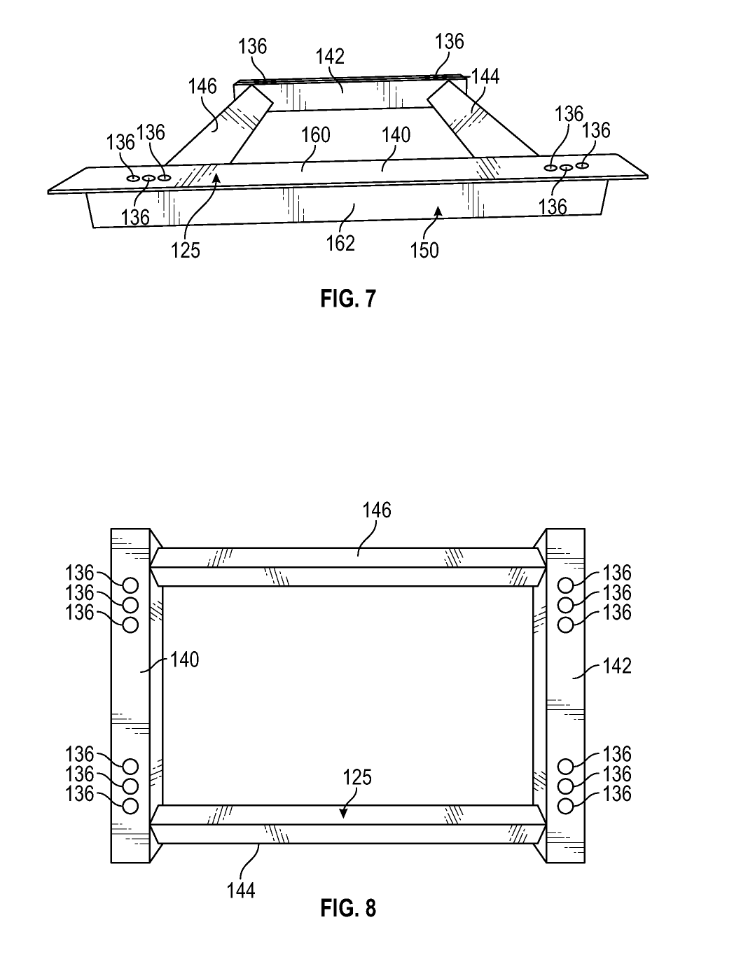

Referring to FIGS. 6-8, the first and second side portions 140 and 142 of each adjustable chock member 120A-D defines a first wall 160 joined to a second wall 162 at a perpendicular angle to collectively define an open channel 150. The open channel 150 is configured to engage a respective one of the first outer member 108, second outer member 110, first inner member 112 and second inner member 114 when engaging the adjustable chock members 120A-D to the frame 102. As shown in FIGS. 6 and 7, the first wall 160 defines a pair of holes 136, while the first outer member 108, second outer member 110, first inner member 112 and second inner member 114 of the frame 102 each define at least three or more holes 138. When securing the adjustable chock member 120A-D to the frame 102, the pair of holes 136 of the adjustable chock member 120 is aligned with any two holes 138 formed along the frame 102. Once the holes 136/138 are properly aligned, a securing member 148 (FIGS. 5 and 6), such as a cotter pin 160, may be inserted through each of the aligned holes 136 and 138 to secure each of the adjustable chock members 120 to the frame 102 at a position that will accommodate the tires of the off-road vehicle 101 therein being hauled by the portable hauler apparatus 100 as illustrated in FIGS. 3 and 4. In this manner, a particular alignment of holes 136/138 permits the adjustable chock member 120 to be positioned at a number of predetermined locations along the frame 102 to accommodate different types of off-road vehicles 101 with varying sizes of wheels and wheel base.

In some embodiments, the first cross bar portion 144 and second cross bar portion 146 of each adjustable chock member 120 may have a substantially angular configuration configured to abut against the tire of the off-road vehicle 101 such that the tire is held stationary when the off-road vehicle 101 is loaded onto the frame 102. However, in other embodiments, the first and second cross bar portions 144 and 146 may have other types of cross-sectional configurations, such has round, square, triangular, oval, and/or rectangular, that provide a structural arrangement for engaging the tire of the off-road vehicle 101 when loaded to the frame 102.

In one aspect, the portable hauler apparatus 100 includes a pair of tires 122 for supporting the frame 102 on an underlying surface, such as a road, when being hauled by a truck or other vehicle. In some embodiments, a pair of roller wheels 124 may be coupled along the first and second inner members 112 and 114 of the frame 102 proximate the rear member 106 as shown in FIG. 3, although in other embodiments the pair of roller wheels 124 may be coupled along the first and second outer members 108 and 110 proximate either the rear member 106 and/or front member 104 of the frame 102. In some embodiments, the roller wheels 124 have a smaller dimension relative to the tires 122 such that the roller wheels 124 are raised above and out of contact with the ground or underlying surface when the frame 102 is aligned in a substantially parallel orientation relative to the ground, such as when the portable hauler apparatus 100 is being hauled by a truck or other suitable hauling vehicle. In addition, the roller wheels 122 provide a means for orienting the frame 102 on an angular surface, such as a rear door ramp 105 of a toy hauler 103 when the portable hauler apparatus 100 is being disassembled as shall be discussed in greater detail below.

As illustrated in FIG. 4, the portable hauler apparatus 100 provides a means for quickly and easily engaging or disengaging the tires 122 and roller wheels 124 relative to the frame 102 during assembly and disassembly. In particular, portable hauler apparatus 100 includes a respective hub assembly 131 comprising an arrangement of securing members 168, hub member 170, a mount 172, and a coupling member 174 that permit each respective tire 122 to be easily and quickly engaged and disengaged from the first and second outer members 108 and 110, respectively, of the frame 102 at different lateral locations defined by each mount 172.

For example, to engage the tires 122 to the frame 102 a respective coupling member 174 is secured to the first and second outer members 108 and 110 of the frame 102 through one or more securing members 168 and a respective hub member 170 then inserted into one of a plurality of holes defined by the mount 172. Once the hub members 170 are secured to each mount 172 at a respective location each tire 122 may be engaged to a respective hub member 170 at that particular location. Conversely, the tires 122 may be disengaged from the frame 102 by disengaging the hub assembly 131 from each tire 122 when disassembling the portable hauler apparatus 100 as shall be described in greater detail below. The tires 122 may be coupled to the respective mount 172 such that the fulcrum established by the connection of each tire 122 to a particular point along the mount 172 provides a particular weight distribution of the frame 102. For example, the tires 122 may be engaged to the respective mount 172 to establish a fulcrum that provides a 60/40 weight distribution between the front and back portions of the frame 102; however, in other arrangements, the engagement of the tires 122 along each respective mount 172 may be changed in order to change the weight distribution of the frame 102 relative to the tires 122.

As further shown in FIG. 4, the portable hauler apparatus 100 includes a respective coupling arrangement 133 configured to engage and disengage the roller wheels 124 relative to the frame 102 when the portable hauler apparatus 100 is being assembled and disassembled. In some embodiments, the coupling arrangement 133 may include a rod and threaded nut arrangement to engage and disengage the roller wheel 124 relative to the frame 102.

Referring back to FIGS. 3 and 11, the portable hauler apparatus 100 may include an extension member 118 configured to be secured to the rear portion of the frame 102 to effectively extend the length of the frame 102 to accommodate a larger off-road vehicle 101. In some embodiments, the extension member 118 may include four extension components 118A-D. In some embodiments, the frame 102 includes a first coupling member 152 secured to the first outer side member 108 and a second coupling member 154 secured to the second outer side member 110 wherein each of the first and second coupling members 152 and 154 are configured to receive a respective portion of the extension members 118B and 118C, respectively, therein when securing the extension member 118 to the frame 102. As further shown, extension component 118A provides lateral structural support to the extension member 118, while extension component 118B is engaged to mount 164.

As shown in FIG. 11, the first and second coupling members 152 and 154 each define a respective conduit (not shown) configured to receive a portion of the extension member 118 therein when securing the extension member 118 to the frame 102. In addition, the first and second coupling members 152 and 154 each define a plurality of apertures 156 that may be aligned with one of a plurality of apertures 158 defined by the extension member 118 in order to secure the extension member 118 to the frame 102. Cotter pins 160 may be inserted through respective aligned apertures 156/158 to secure the extension 118 to the first and second coupling members 152 and 154. In this arrangement, the extension member 118 is in telescopic relation to the first and second coupling member 152 and 154 of frame 102 such that the extension member 118 may be extended various predetermined distances from the frame 102 to accommodate different types of off-road vehicles 101.

In some embodiments, the portable hauler apparatus 100 may include a trailer hitch arrangement 126 configured to be engaged and disengaged from the frame 102 as illustrated in FIGS. 3 and 4. The trailer hitch arrangement 126 may include a connecting rod 162 configured to engage a mount 164 of the frame 102. In addition, the trailer hitch arrangement 126 may include a wheel assembly 166 that extends in perpendicular relation relative to the connecting rod 162 for providing a tri-wheel arrangement with tires 122.

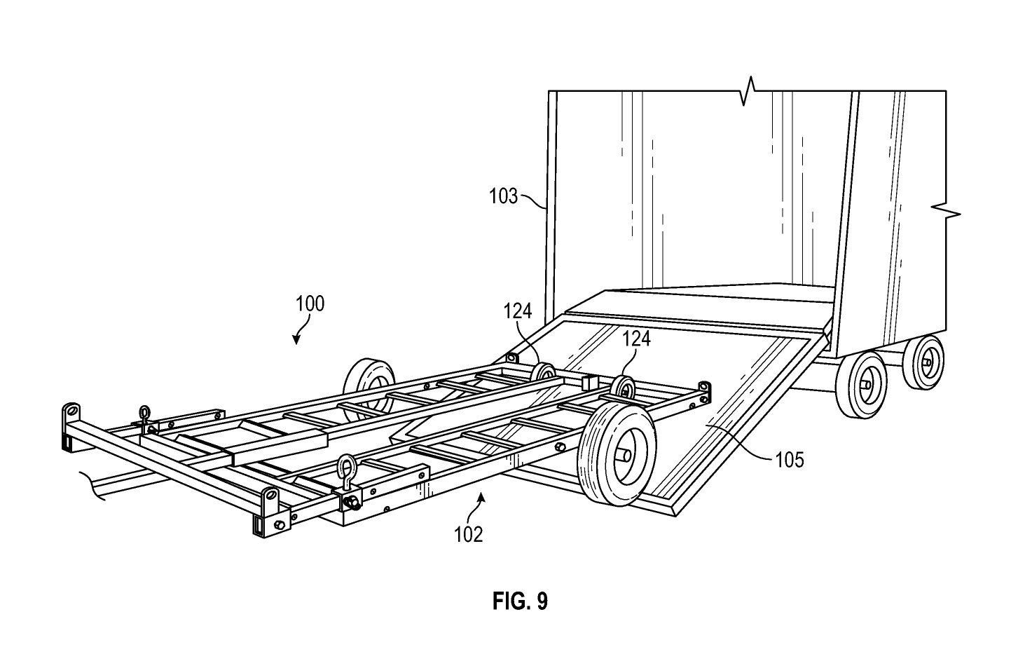

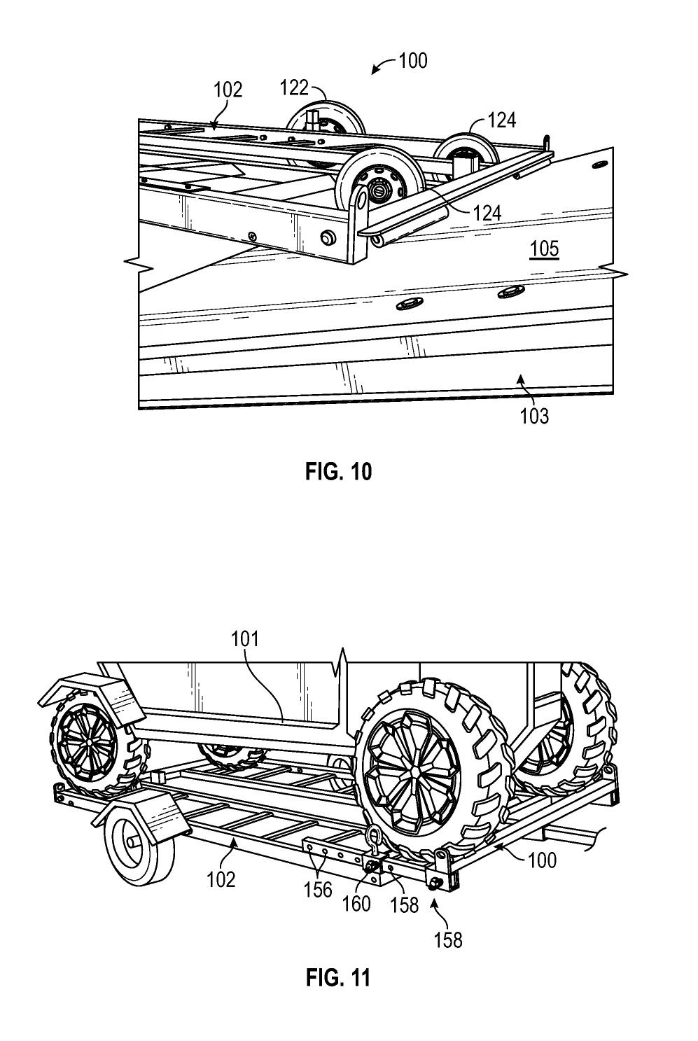

In one method of use, the portable hauling apparatus 100 may be disassembled and stored inside the toy hauler 103 or other travel trailer having a rear ramp door 105. As shown in FIGS. 9 and 10, the roller wheels 124 of the portable hauler apparatus 100 may be ridden up the rear door ramp 105 of the toy hauler 101 such that the tires 122 of the frame 102 are raised above the ground or underlying surface. In this orientation, the tires 122 may be disengaged from the frame 102 by decoupling the hub assembly 131 for each tire 122 as described above. Once the tires 122 are disengaged, the frame 102 may be rolled into a garage area (not shown) of the toy hauler 103 using the roller wheels 124. The roller wheels 124 and trailer hitch arrangement 126 may then be disengaged from the frame 102 such that the portable hauler apparatus 100 is completely disassembled and configured for storage.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A portable hauler apparatus comprising:
a frame comprising:
a first outer member and a first inner member that extend in parallel between a front member and a rear member to collectively define a first channel portion, and
a second outer member and a second inner member that extend in parallel between the front member and the rear member to collectively define a second channel portion;
a first tire coupled to the first outer member and a second tire coupled to the second outer member; and
a plurality of adjustable chock members configured to be coupled along the first and second channel portions, respectively, such that respective chock areas are established to accommodate a respective tire of a vehicle loaded onto the frame.

2. The portable hauler apparatus of claim 1, further comprising:
a first plurality of cross members extending between the first outer member and the first inner member and a second plurality of cross members extending between the second outer member and the second inner member.

3. The portable hauler apparatus of claim 1, wherein each of the plurality adjustable chock members comprising opposite first and second side portions and opposite first and second cross bar portions that collectively form a chock configured to accommodate the respective tire of the vehicle being loaded onto the frame.

4. The adjustable hauler apparatus of claim 3, wherein each of the first and second cross bar portions defines at least one of a triangular-shaped cross-sectional configuration, an angular-shaped cross-sectional configuration, a square-shaped cross-sectional configuration, and a round-shaped cross-sectional configuration.

5. The adjustable hauler apparatus of claim 3, wherein each of the first and second side portions define a first wall and a second wall that collectively form an open channel configured to engage the first and second outer members, respectively.

6. The adjustable hauler apparatus of claim 1, further comprising:
first and second roller wheels coupled to the frame proximate the rear member and/or front member.

7. The adjustable hauler apparatus of claim 6, wherein the first and second roller wheels have a smaller dimension than the first and second tires.

8. The adjustable hauler apparatus of claim 1, further comprising:
an extension member coupled to the frame for extending the length of the frame.

9. The adjustable hauler apparatus of claim 1, wherein each of the first and second tires is coupled to the frame through a hub assembly, the hub assembly comprising:
a coupling member secured onto the frame, the coupling member including a mount;
a hub member secured to the coupling member through engagement with the mount, the hub member being configured to engage the first tire and the second tire; and
a plurality of securing members for securing the coupling member to the hub assembly.

10. The adjustable hauler apparatus of claim 1, further comprising:
a trailer hitch arrangement configured to be engaged and disengaged from the frame.

11. A method of disassembling a portable hauler apparatus using a ramp of a trailer comprising:
moving a portable hauler apparatus along a ramp of a trailer with the ramp being oriented at an angle relative to an underlying surface, the portable hauler apparatus comprising:
a frame comprising:
a first outer member and a first inner member that extend in parallel between a front member and a rear member to collectively define a first channel portion, and
a second outer member and a second inner member that extend in parallel between the front member and the rear member to collectively define a second channel portion;
a first tire coupled to the first outer member and a second tire coupled to the second outer member; and
a first roller wheel and a second roller wheel coupled to the frame;
orienting the frame in a substantially parallel manner relative to the underlying surface such that the first and second tires are raised above the underlying surface;
disengaging the first and second tires from the frame; and
driving the first and second roller wheels upward relative to the underlying surface until the frame is disposed within the trailer.

12. The method of claim 11, further comprising:
removing the first and second tires from the frame using a hub assembly configured to engage and disengage the first and second tires, respectively, from the frame.

13. The method of claim 11, further comprising:
disengaging the first and second roller wheels from the frame once the first and second tires are disengaged and the frame is disposed within the trailer.

14. A method of using adjustable chock members to establish a plurality of chock areas along a frame comprising:
providing a portable hauler apparatus comprising:
a frame comprising:
a first outer member and a first inner member that extend in parallel between a front member and a rear member to collectively define a first channel portion, and
a second outer member and a second inner member that extend in parallel between the front member and the rear member to collectively define a second channel portion; and
a first tire coupled to the first outer member and a second tire coupled to the second outer member.
a plurality of adjustable chock members configured to be coupled along the first and second channel portions, respectively, such that respective chock areas are established to accommodate a respective tire of a vehicle loaded onto the frame; and
engaging a plurality of adjustable chock members along one of a respective plurality of predetermined locations defined along the first and second channel portions of the frame to establish a plurality of chock areas configured to engage a tire of a vehicle mounted to the frame.

15. The method of claim 14, wherein the plurality of predetermined locations are defined by apertures formed through the frame.

16. The method of claim 14, further comprising:
coupling each of the first and second tires to the frame through a respective hub assembly, each hub assembly comprising:
a coupling member secured onto the frame, the coupling member including a mount defining a plurality of apertures;
a hub member secured to the coupling member through engagement with the mount at the one of the plurality of apertures, the hub member being configured to engage the first tire and the second tire; and
a plurality of securing members for securing the coupling member to the hub assembly.

17. The method of claim 16, further comprising:
coupling each tire at another aperture along the mount to change the weight distribution of the frame.

18. The method of claim 17, wherein coupling each tire at another aperture along the mount changes the weight distribution along the frame.
